(19) United States
(12) Patent Application Publication
(10) Pub. No.: US 2017/0373410 A1
(43) Pub. Date: Dec. 28, 2017

(54) BATTERY CLAMP

(71) Applicant: Midtronics, Inc., Willowbrook, IL (US)

(72) Inventors: Luba Lipkin, Buffalo Grove, IL (US); Andrew John Salo, III, Hinsdale, IL (US); Kevin I. Bertness, Batavia, IL (US)

(21) Appl. No.: 15/634,491

(22) Filed: Jun. 27, 2017

Related U.S. Application Data
(60) Provisional application No. 62/355,465, filed on Jun. 28, 2016.

(51) Int. Cl. H01R 11/24; H01R 11/28

(52) U.S. Cl. CPC H01R 11/24; H01R 11/281

(57) ABSTRACT

A clamp for providing an electrical connection to a battery includes a first arm, a second arm, a joint member, a first pivotable connection, and a second pivotable connection. The first arm includes a proximal end, a distal end, and an electrically conductive member at the distal end. The second arm includes a proximal end and a distal end. The first pivotable connection is between the joint member and the first arm, and defines a first axis, about which the first arm rotates relative to the joint member. The second pivotable connection is between the joint member and the second arm, and defines a second axis, about which the second arm rotates relative to the joint member. The first and second axes are displaced from each other in a direction that is perpendicular to the first axis.

### CROSS-REFERENCE TO RELATED APPLICATION

The present application is based on and claims the benefit of U.S. provisional patent application Ser. No. 62/355,465, filed Jun. 28, 2016, the content of which is hereby incorporated by reference in its entirety.

Embodiments of the present disclosure generally relate to clamps for electrically coupling to storage batteries.

Battery clamps are typically used to electrically couple cables to the terminals of storage batteries. For example, battery clamps may be used to connect jumper cables or battery charger cables to the terminals of a storage battery.

Conventional battery clamps, such as the clamp 500 shown in the side plan view of FIG. 5, and that disclosed in U.S. Published Application No. 2015/0200470, which is incorporated herein by reference in its entirety, include arms 502 and 504 that are pivotably connected to each other at a single pivotable connection 506 that is formed between the arms 502 and 504. The single pivotable connection defines a single axis of rotation 510 about which the aims 502 and 504 pivot or rotate relative to each other. Handle sections 508 of the arms 502 and 504 may be squeezed by a user to pivot the arms 502 and 504 about the axis 510 of the pivotable connection 506 to transition jaw sections 512 of the arms 502 and 504 to an open position, which is shown in FIG. 5. The user can release the handle sections 508 to pivot the arms 502 and 504 about the axis 510, and transition the jaw sections 512 to a closed or gripping position to connect to a terminal of a battery, for example.

### SUMMARY

Embodiments of the present disclosure are directed to a clamp for providing an electrical connection, such as an electrical connection to a battery. In some embodiments, the clamp includes a first arm, a second arm, a joint member, a first pivotable connection, and a second pivotable connection. The first arm includes a proximal end, a distal end, and an electrically conductive member at the distal end. The second arm includes a proximal end and a distal end. The first pivotable connection is between the joint member and the first arm, and defines a first axis about which the first arm is configured to rotate relative to the joint member. The second pivotable connection is between the joint member and the second arm, and defines a second axis about which the second arm is configured to rotate relative to the joint member. The first and second axes are displaced from each other in a direction that is perpendicular to the first axis.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the Background.

### BRIEF DESCRIPTION OF THE DRAWINGS

FIG. 1 is a simplified diagram of an exemplary clamp, in accordance with embodiments of the present disclosure.

FIGS. 2 and 3 are side views of an exemplary clamp respectively in closed and opened positions, in accordance with embodiments of the present disclosure.

FIG. 4 is an isometric view of a distal end of an exemplary clamp, in accordance with embodiments of the present disclosure.

FIG. 5 shows a side plan view of an exemplary clamp, in accordance with the prior art.

### DETAILED DESCRIPTION OF ILLUSTRATIVE EMBODIMENTS

Embodiments of the present disclosure are described more fully hereinafter with reference to the accompanying drawings. Elements that are identified using the same or similar reference characters refer to the same or similar elements. The various embodiments of the present disclosure may, however, be embodied in many different forms and should not be construed as limited to the embodiments set forth herein. Rather, these embodiments are provided so that this disclosure will be thorough and complete, and will fully convey the scope of the present disclosure to those skilled in the art.

Specific details are given in the following description to provide a thorough understanding of the embodiments. However, it is understood by those of ordinary skill in the art that the embodiments may be practiced without these specific details. For example, circuits, systems, networks, processes, frames, supports, connectors, motors, processors, and other components may not be shown, or shown in block diagram form in order to not obscure the embodiments in unnecessary detail.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element is referred to as being “connected,” “coupled,” or “attached” to another element, it can be directly connected, coupled or attached to the other element, or it can be indirectly connected, coupled, or attached to the other element where intervening or intermediate elements may be present. In contrast, if an element is referred to as being “directly connected,” “directly coupled” or “directly attached” to another element, there are no intervening elements present. Drawings illustrating direct connections, couplings, or attachments between elements also include embodiments, in which the elements are indirectly connected, coupled or attached to each other.

It will be understood that, although the terms first, second, etc. may be used herein to describe various elements, these elements should not be limited by these terms. These terms are only used to distinguish one element from another. Thus, a first element could be termed a second element without departing from the teachings of the present disclosure.

Unless otherwise defined, all terms (including technical and scientific terms) used herein have the same meaning as commonly understood by one of ordinary skill in the art relating to the present disclosure. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Embodiments of the present disclosure are directed to a clamp for providing an electrical connection, such as, for example, a battery clamp for providing an electrical connection to a storage battery (e.g., an automotive battery) or a battery charger.

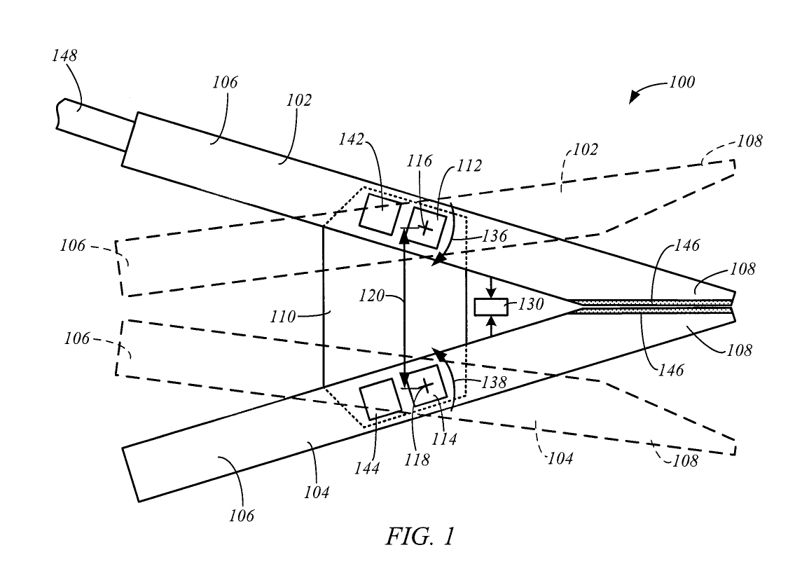

FIG. 1 is a simplified diagram of an exemplary clamp 100, in accordance with embodiments of the present disclosure. In some embodiments, the clamp 100 includes arms 102 and 104 each having a proximal end 106 and distal end 108. The clamp 100 also includes a joint member 110, which may be positioned between the arms 102 and 104.

Pivotable or rotatable connections 112 and 114 respectively connect the arms 102 and 104 to the joint member 110. The connection 112 between the arm 102 and the member 110 facilitates pivoting or rotational movement of the arm 102 about an axis 116 relative to the joint member 110, and the connection 114 between the arm 104 and the member 110 facilitates pivoting or rotational movement of the arm 104 relative to the member 110 about an axis 118. Thus, the pivotable connection 112 defines the axis 116 and the pivotable connection 114 defines the axis 118. The pivotable or rotatable connections 112 and 114 may take on any suitable form, such as a pivot joint, a hinge joint, a rotary joint, or another suitable pivotable or rotatable connection.

The axes 116 and 118 are separated from each other by a distance 120 in a direction that is perpendicular to the axis 116. In some embodiments, the axes 116 and 118 are substantially parallel to each other (i.e., ±15°), and the distance 120 extends along a plane that is parallel to the axes 116 and 118. In some exemplary embodiments, the distance 120 is approximately (i.e., ±10%) greater than 0.5 inch, greater than 1.0 inch, and greater than 2.0 inches.

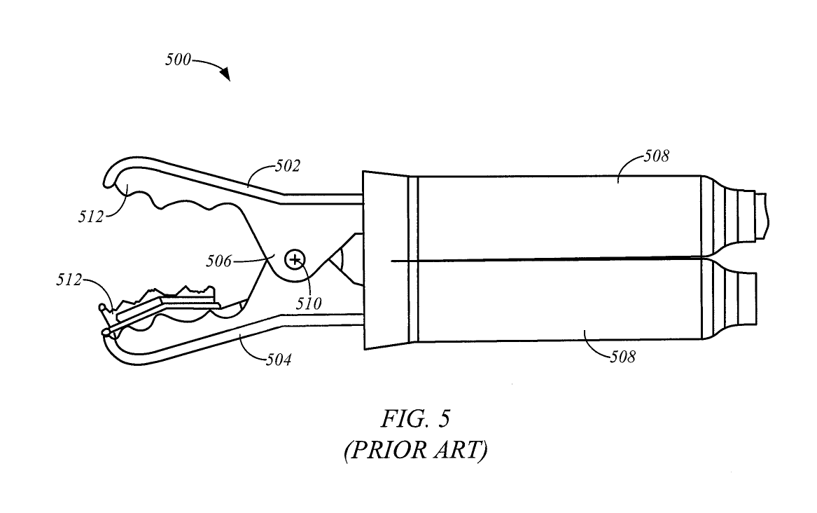

The dual pivotable connections 112 and 114 of the clamp 100, which results in the separated axes of rotation 116 and 118 for the arms 102 and 104, allow the distal ends 108 of the arms 102 and 104 to be configured to have a wider opened position (shown in phantom lines) than would be possible if the arms 102 and 104 were connected in the conventional manner to share the same axis of rotation, such as illustrated by the clamp 500 shown in FIG. 5. As a result, the clamp 100 formed in accordance with embodiments of the present disclosure, can be configured to have a wider gap between the distal ends 108 than conventional clamps, thereby allowing the clamp 100 to grip larger battery terminals or other items than conventional battery clamps. In some embodiments, the distal ends 108 of the arms 102 and 104 of the clamp 100 are capable of opening 50-60% wider than a similarly sized conventional single pivot point clamp, such as clamp 500 shown in FIG. 5.

In some embodiments, the clamp 100 includes a biasing mechanism 130 that is configured to bias the arms 102 and 104 toward a closed or gripping position, as shown in solid lines in FIG. 1. That is, the biasing mechanism 130 is configured to drive rotation of the arm 102 about the axis 116 relative to the member 110 in the direction indicated by arrow 136, and the biasing mechanism 130 is configured to drive rotation of the arm 104 about the axis 118 relative to the member 110 in the direction indicated by arrow 138. A user may overcome this biasing force applied to the arms 102 and 104 by squeezing the proximal ends 106 of the arms 102 and 104 together to transition the clamp 100 to an open position, which is indicated in phantom lines in FIG. 1. The biasing mechanism 130 may take on any suitable form and include one or more spring members, such as a coil spring, or another suitable biasing member.

The clamp 100 may also include cooperating features 142 and 144 for limiting the degree to which the arms 102 and 104 may pivot about their respective axes 116 and 118 relative to the member 110, to thereby limit the open and/or closed positions of the arms 102 and 104. The cooperating features 142 and 144 may take on any suitable form including those discussed in greater detail below.

In some embodiments, the distal end 108 of the arm 102 and/or the arm 104 includes one or more conductive members 146 that are configured to provide an electrical connection to a battery terminal or other feature gripped by the conductive members 146. The conductive members 146 may be electrically connected to each other through, for example, the member 110, and/or another electrically conductive element, such as an electrical cable.

In some embodiments, the clamp 100 includes an electrical cable 148 that is electrically coupled to at least one of the conductive members 146. When, for example, the clamp 100 is secured to a terminal of a battery, an electrical current is capable of flowing through at least one of the conductive members 146 and the cable 148 to a desired target, such as an automotive battery charger, a battery tester, or another target.

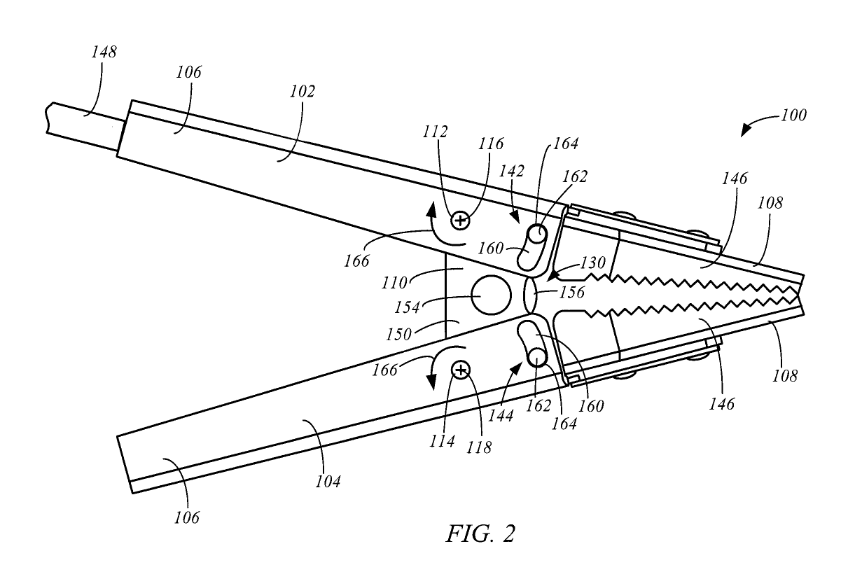

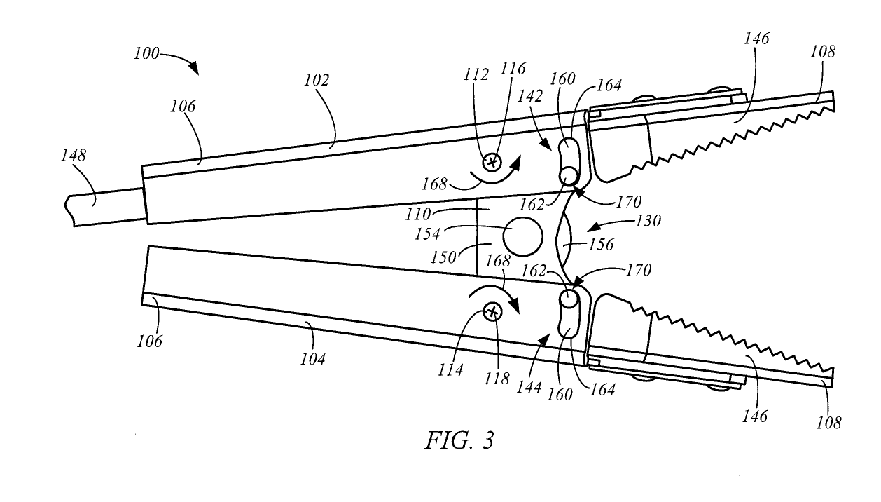

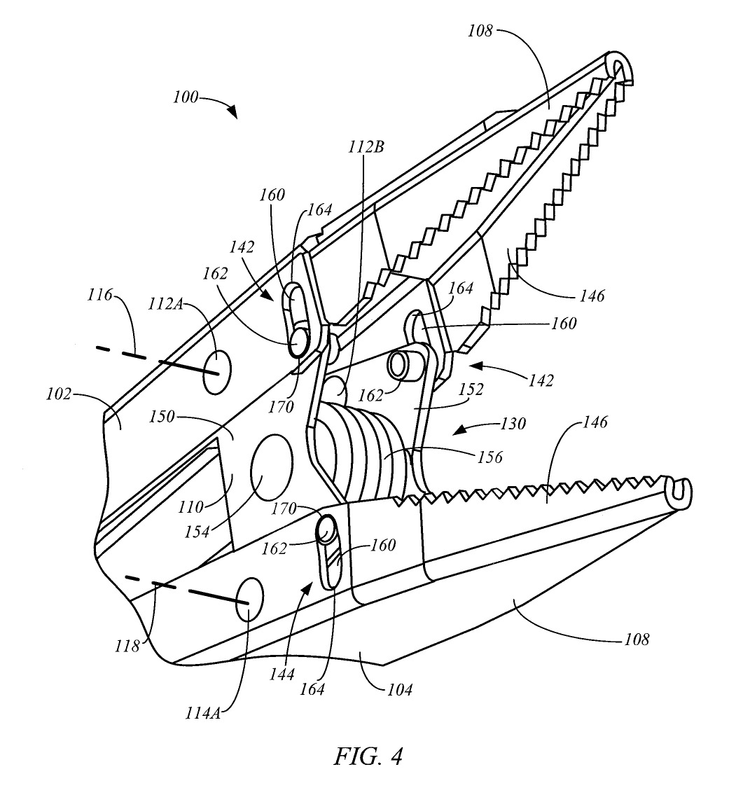

Additional embodiments of the present disclosure will be described with reference to FIGS. 2-4. FIGS. 2 and 3 are side views of an exemplary clamp 100 respectively in closed and opened positions, in accordance with embodiments of the present disclosure. FIG. 4 is an isometric view of a distal end of an exemplary clamp 100, in accordance with embodiments of the present disclosure. Elements that are identified using the same or similar reference numbers as those discussed above with reference to FIG. 1 correspond to the same or similar elements.

In some embodiments, the arms 102 and 104 are rigid structures, which may be formed of one or more components. For example, the arms 102 and 104 may be formed of one or more sheet metal components that may be bent into U-shaped cross-sections, such as shown in FIG. 4. Alternatively, the arms 102 and 104 may be tubular or solid structures, for example.

The joint member 110 may be formed in any suitable manner. In some embodiments, the joint member 110 includes side walls 150 and 152. The arm 102 is pivotably attached to one or both of the walls 150 and 152 of the member 110 through the pivotable connection 112. For instance, the arm 102 may be pivotably or rotatably attached to the wall 150 at a pivotable or rotatable connection 112A, and/or pivotably or rotatably attached to the wall 152 at a pivotable or rotatable connection 112B, as shown in FIG. 4. Similarly, the arm 104 may be pivotably or rotatably attached to one or both of the walls 150 and 152 through the pivotable connection 114. For instance, the arm 104 may be pivotably or rotatably attached to the wall 150 at a pivotable or rotatable connection 114A, and/or similarly pivotably or rotatably attached to the wall 152 through a suitable pivotable or rotatable connection (not shown). As mentioned above, each of the pivotable or rotatable connections 112 and 114 may take on any suitable form, such as a pivot joint, a hinge joint, or a rotary joint, for example.

The side walls 150 and 152 of the joint member 110 may be joined together using any suitable technique. In some embodiments, a pin or rod 154 extends between the walls 150 and 152. Other connections may also be made between the side walls 150 and 152.

In some embodiments, the pin 154 supports the biasing mechanism 130, which may include a spring member 156 (e.g., a coil spring), as best shown in FIG. 4, and/or another suitable biasing mechanism. In some embodiments, the spring 156 is coiled around the pin 154 and presses against the proximal side of the arms 102 and 104 (toward ends 106) from their corresponding pivotable connections 112 and 114 to the walls 150 and/or 152 of the member 110. This applies a biasing or closing force to the arms 102 and 104, which drives the arms 102 and 104 toward the closed position, shown in FIG. 1 (solid lines) and FIG. 2. A user may press the proximal ends 106 of the arms 102 and 104 together to overcome the closing force applied to the arms 102 and 104 by the spring 156, and transition the clamp 100 to the opened position shown in FIG. 1 (phantom lines), FIG. 3 and FIG. 4.

In some embodiments, the cooperating features 142 and 144 may include slots 160, and pins 162 that extend through the slots and limit the rotation of the arms 102 and 104 relative to the joint member 110. For example, the arms 102 and 104 may include the slots 170, and the member 110 may support a pair of pins 162 that extend through the slots 160 and restrict the angular rotation of the arms 102 and 104 about their corresponding pivot axes 116 and 118 relative to the member 110. In some embodiments, the closed position (FIG. 1) of the clamp 100 is partially determined by the pins 162 engaging an end 164 of the corresponding slot 160, as shown in FIG. 2. This engagement between the pins 162 and the ends 164 of the slots 160 prevents further rotation of the arms 102 and 104 about their pivot axes 116 and 118 in the direction indicated by arrows 166.

Similarly, in some embodiments, rotation of the arms 102 and 104 about their corresponding pivot axes 116 and 118 in the direction indicated by arrows 168 is limited by engagement between the pins 162 and an end 170 of the slots 160, as shown in FIG. 3. Thus, in some embodiments, the fully opened position of the clamp 100 is limited by the engagement between the pins 162 and the ends 170 of the slots 160, as shown in FIG. 3. In some embodiments, the cooperating features 142 and 144 limit a fully opened position to a position that prevents the proximal ends of the arms 102 and 104 from contacting each other. This may, for example, be useful in preventing abrasion to the cable 148 through contact with the proximal end 106 of the arm 104.

The slots 160 and pins 162 of the exemplary cooperating features 142 and 144 described above may be reversed. Thus, in some embodiments, the slots 160 may be formed in one or both of the walls 152 and 154 of the member 110, and the pins 162 may be attached to the arms 102 and 104. Other forms of the cooperating features 142 and 144 may also be used.

Although the embodiments of the present disclosure have been described with reference to preferred embodiments, workers skilled in the art will recognize that changes may be made in form and detail without departing from the spirit and scope of the present disclosure.

What is claimed is:

1. A clamp for providing an electrical connection to a battery comprising:
a first arm having a proximal end, a distal end, and an electrically conductive member at the distal end;
a second arm having a proximal end, and a distal end;
a joint member;
a first pivotable connection between the joint member and the first arm defining a first axis about which the first arm is configured to rotate relative to the joint member; and
a second pivotable connection between the joint member and the second arm defining a second axis about which the second arm is configured to rotate relative to the joint member;
wherein the first and second axes are displaced from each other in a direction that is perpendicular to the first axis.

2. The clamp according to claim 1, wherein the first and second axes are substantially parallel to each other.

3. The clamp according to claim 2, wherein the first and second axes are displaced from each other a distance measured in a plane that is parallel to the first and second axes.

4. The clamp according to claim 3, wherein the distance is approximately greater than 0.5 inch.

5. The clamp according to claim 3, wherein the distance is approximately greater than 1.0 inch.

6. The clamp according to claim 3, wherein the distance is approximately greater than 2.0 inches.

7. The clamp according to claim 3, further comprising a biasing mechanism supported by the joint member and configured to bias the distal ends of the first and second arms toward each other.

8. The clamp according to claim 7, wherein the biasing mechanism comprises a spring member.

9. The clamp according to claim 8, wherein:
the joint member includes a pair of opposing side walls and a pin extending between the side walls; and
the spring member is supported by the pin.

10. The clamp according to claim 7, wherein:
the first arm and the joint member include first cooperating features that are configured to limit a rotation of the first arm about the first axis relative to the joint member; and
the second arm and the joint member include second cooperating features that are configured to limit rotation of the second arm relative to the joint member about the second axis.

11. The clamp according to claim 10, wherein the first and second cooperating features each include a slot and a pin, wherein the pin is received within the slot.

12. The clamp according to claim 10, wherein the clamp includes an electrical cable that is electrically coupled to the conductive member.

13. The clamp according to claim 12, wherein the distal end of the second arm includes a conductive member that is electrically coupled to the electrical cable.

14. The clamp according to claim 1, wherein the first and second pivotable connections each include one of pivot joint, a hinge joint, and a rotary joint.

15. A clamp for providing an electrical connection to a battery comprising:
a first arm having a proximal end, a distal end, and an electrically conductive member at the distal end;
a second arm having a proximal end, and a distal end;
a joint member;
a first pivotable connection between the joint member and the first arm defining a first axis about which the first arm is configured to rotate relative to the joint member;
a second pivotable connection between the joint member and the second arm defining a second axis about which the second arm is configured to rotate relative to the joint member;
a biasing mechanism supported by the joint member and configured to bias the distal ends of the first and second arms toward each other; and
an electrical cable that is electrically coupled to the conductive member;
wherein:
the first and second axes are substantially parallel to each other; and
the first and second axes are displaced from each other in a direction that is perpendicular to the first axis.

16. The clamp according to claim 15, wherein:
the first and second axes are displaced from each other a distance measured in a plane that is parallel to the first and second axes; and
the distance is selected from the group consisting of approximately greater than 0.5 inch, approximately greater than 1.0 inch, and approximately greater than 2.0 inches.

17. The clamp according to claim 16, wherein:
the joint member includes a pair of opposing side walls and a pin extending between the side walls; and
the biasing mechanism includes a spring member that is supported by the pin.

18. The clamp according to claim 17, wherein:
the first arm and the joint member include first cooperating features that are configured to limit a rotation of the first arm about the first axis relative to the joint member; and
the second arm and the joint member include second cooperating features that are configured to limit rotation of the second arm relative to the joint member about the second axis.

19. The clamp according to claim 18, wherein the first and second cooperating features each include a slot and a pin, wherein the pin is received within the slot.

20. The clamp according to claim 16, wherein the first and second pivotable connections each include one of pivot joint, a hinge joint, and a rotary joint.
